(19) United States
(12) Patent Application Publication
(10) Pub. No.: US 2023/0133039 A1
(43) Pub. Date: May 4, 2023

(54) Automated Food Preparation System

(71) Applicant: Nala Robotics, Inc., Arlington Heights, IL (US)

(72) Inventors: Vijay Kodali, Palatine, IL (US); Ajay Kumar Sunkara, South Barrington, IL (US)

(21) Appl. No.: 17/516,071

(22) Filed: Nov. 1, 2021

(51) Int. Cl. B25J 11/00; B25J 9/00; B25J 15/00

(52) U.S. Cl. CPC B25J 11/0045; B25J 9/0009; B25J 15/0019; B25J 11/008

(57) ABSTRACT

A pizza making system in an automated kitchen, where the pizza making system includes a pneumatic arm having a gripper supported on a base in the automated kitchen, a storage box arranged in the automated kitchen, within a reaching distance of the pneumatic arm; a press arranged in the automated kitchen, within a reaching distance of the pneumatic arm; a dosing and distribution device arranged in the automated kitchen, within a reaching distance of the pneumatic arm; a toppings device arranged in the automated kitchen, within a reaching distance of the pneumatic arm; an oven arranged in the automated kitchen, within a reaching distance of the pneumatic arm; and a cutting station arranged in the automated kitchen, within a reaching distance of the pneumatic arm. The storage box, press, dosing and distribution device, toppings device, oven, and cutting station are in a substantially ring-shaped production line around the pneumatic arm.

### BACKGROUND

Preparing individually ordered and customized dishes often requires resting, lifting, and maneuvering food items and ingredients with respect to appliances and supporting surfaces for processing the food items or making kitchen resources available for other tasks in a recipe. As such, there is a need in automated kitchens employing robot arms to carry out recipes to provide detachable utensils adapted for robot arms configured to reliably engage robot arms and food items in appliances or on supporting surfaces.

### BRIEF DESCRIPTION

According to one aspect, an end effector includes a handle having a proximal end portion and a distal end portion extended from the proximal end portion in a longitudinal direction of the handle, the handle being formed from a wall closed around the longitudinal direction of the handle with an interior side that defines an aperture configured for receiving a robot arm, and extended from the proximal end portion to the distal end portion, and a plate fixed with the distal end portion of the handle, and extended away from the proximal end portion of the handle.

According to another aspect, an automated food preparation system has an end effector including a handle having a proximal end portion and a distal end portion extended from the proximal end portion in a longitudinal direction of the handle, and a plate fixed with the distal end portion of the handle, and including at least one blade extended away from the proximal end portion of the handle, in the longitudinal direction of the handle. The automated food preparation system also has a base including a supporting surface and ejector pins arranged in the supporting surface, configured for being actuated to a retracted position where the ejector pins are flush with the supporting surface, and configured for being actuated to an extended position where the ejector pins are projected from the supporting surface, the ejector pins being offset from each other to define at least one gap therebetween along the supporting surface when actuated to the extended position, where the at least one gap is wider than the at least one blade such that the at least one blade is configured for being inserted in the at least one gap, the blade having a bottom surface configured for engaging or facing the supporting surface from a position interposed between and separating the ejector pins across the at least one gap along the supporting surface, and a top surface configured for engaging associated food items from a position between protruding ends of the ejector pins and the supporting surface in a direction in which the ejector pins are actuated.

### BRIEF DESCRIPTION OF THE DRAWINGS

FIG. 1 is a perspective view of an end effector.

FIG. 2 is an exploded perspective view of the end effector.

FIG. 3 is a top view of the end effector.

FIG. 4 is a side view of the end effector.

FIG. 5 is a front view of the end effector.

FIG. 6 is a perspective view of a plate and a stem of the end effector, assembled together.

FIG. 7 is a top view of the plate and the stem assembled together.

FIG. 8 is a side view of the plate and the stem assembled together.

FIG. 9 is a perspective view of a handle of the end effector.

FIG. 10 is a side view of the handle.

FIG. 11 is a back view of the handle.

FIG. 12 is an enlarged partial view of the handle.

FIG. 13 is a front view of the handle.

FIG. 14 is a cross-sectional side view of the handle.

FIG. 15 is a perspective view of a connector included in the handle.

FIG. 16 is a front view of the connector.

FIG. 17 is a side view of the connector.

FIG. 18 is a back view of the connector.

FIG. 19 is a perspective view of the plate, the stem, and the connector assembled together.

FIG. 20 is a top view of the plate, the stem, and the connector assembled together.

FIG. 21 is a side view of the plate, the stem, and the connector assembled together.

FIG. 22 is a front view of the plate, the stem, and the connector assembled together.

FIG. 23 is a perspective view of an alternative embodiment of the end effector.

FIG. 24 is an exploded view of the embodiment of the end effector of FIG. 23.

FIG. 25 is a side view of the embodiment of the end effector of FIG. 23.

FIG. 26 is a top view of the embodiment of the end effector of FIG. 23.

FIG. 27 is a front view of the embodiment of the end effector of FIG. 23.

FIG. 28 is a perspective view of an alternative embodiment of the end effector.

FIG. 29 is a top view of the embodiment of the end effector of FIG. 28.

FIG. 30 is a front view of the embodiment of the end effector of FIG. 28.

FIG. 31 is a side view of the embodiment of the end effector of FIG. 28.

FIG. 32 is a perspective view of a panel included in the embodiment of the end effector of FIG. 28.

FIG. 33 is a top view of the panel of the end effector of FIG. 28.

FIG. 34 is a side view of the panel of the end effector of FIG. 28.

FIG. 35 is a perspective view of a backing included in the embodiment of the end effector of FIG. 28.

FIG. 36 is a top view of the backing of the end effector of FIG. 28.

FIG. 37 is a front view of the backing of the end effector of FIG. 28.

FIG. 38 is a front view of the backing of the end effector of FIG. 28 in an intermediate stage of manufacture.

FIG. 39 is a perspective view of a base.

FIG. 40 is a perspective view of an alternative embodiment of the end effector.

FIG. 41 is a perspective view of an alternative embodiment of the end effector.

### DETAILED DESCRIPTION

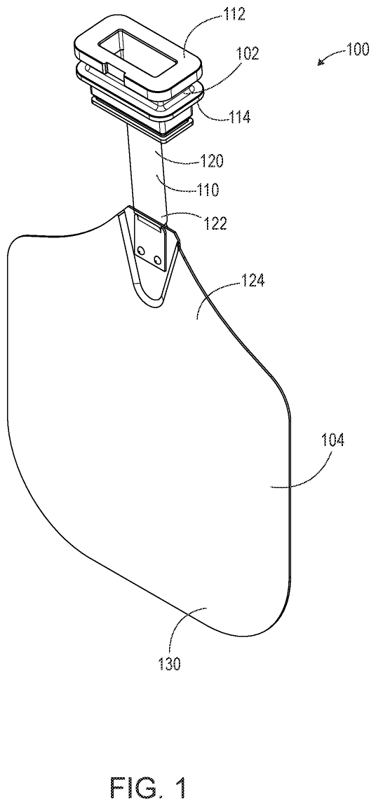

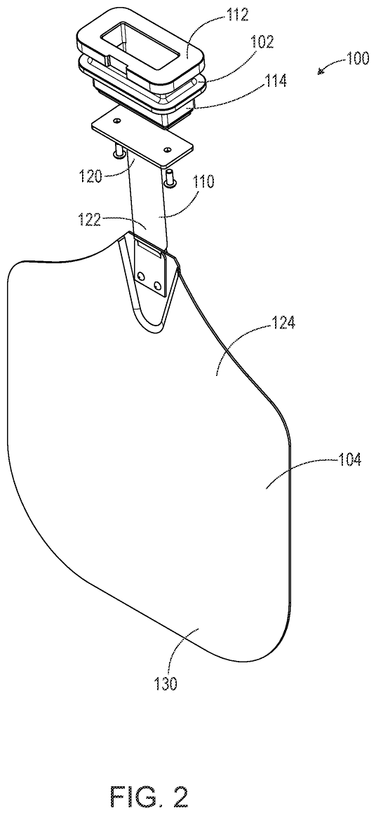

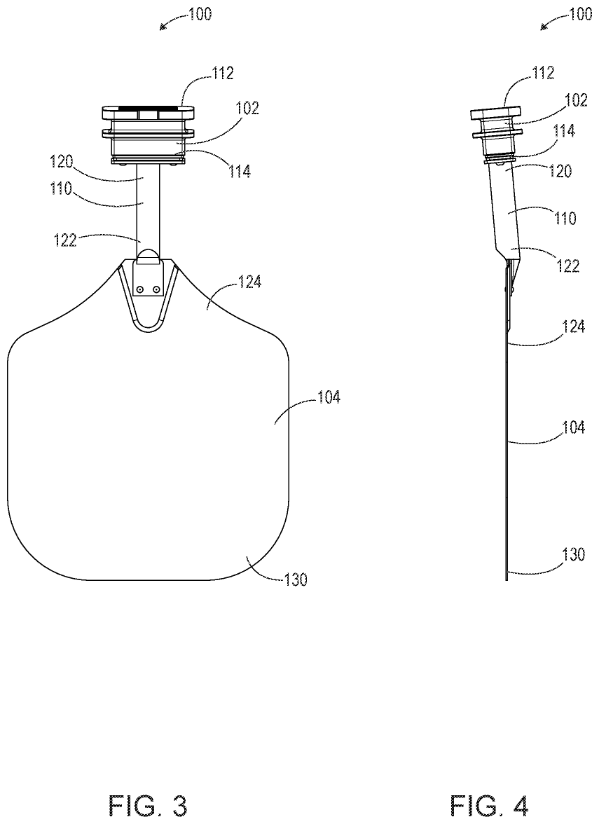

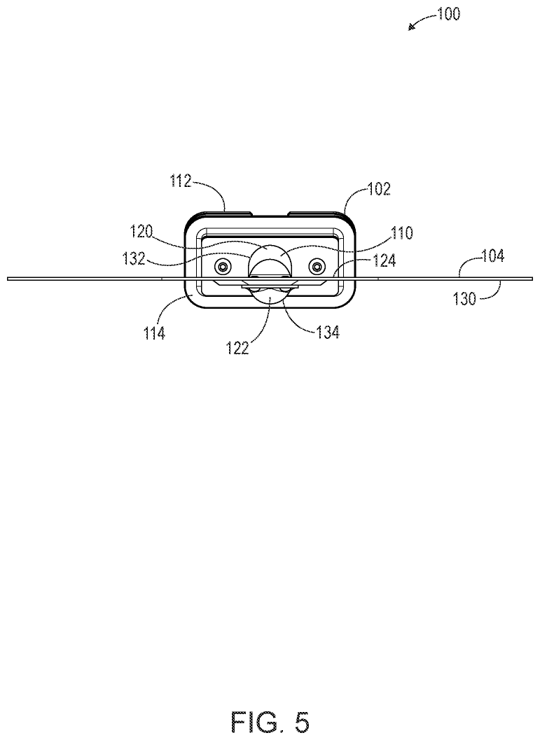

It should, of course, be understood that the description and drawings herein are merely illustrative and that various modifications and changes can be made in the structures disclosed without departing from the present disclosure. Referring now to the drawings, wherein like numerals refer to like parts throughout the several views, FIGS. 1-5 respectively depict an end effector 100 for a robot arm (not shown) including a handle 102 connected to a plate 104 through a stem 110. As depicted, the handle 102 includes a handle proximal end portion 112 and a handle distal end portion 114 extended from the handle proximal end portion 112 in a longitudinal direction of the handle 102. The stem 110 includes a stem proximal end portion 120 fixed to the handle 102, and a stem distal end portion 122 extended from the stem proximal end portion 120 in a longitudinal direction of the stem 110 that is parallel with the longitudinal direction of the handle 102. The plate 104 includes a plate proximal end portion 124 fixed to the stem 110, and a plate distal end portion 130 extended from the plate proximal end portion 124 in a longitudinal direction of the plate 104 directed along the longitudinal direction of the handle 102 and the longitudinal direction of the stem 110, away from the handle proximal end portion 112. As shown in FIG. 4, the longitudinal direction of the plate 104 is angled offset from the longitudinal direction of the handle 102 and the longitudinal direction of the stem 110.

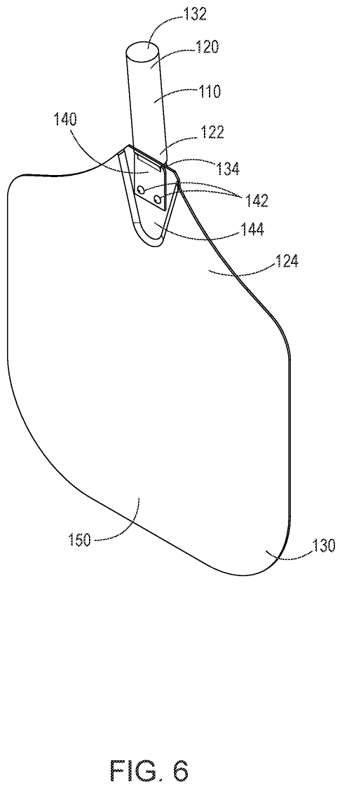

FIGS. 6-8 depict the plate 104 assembled with the stem 110. As shown, the stem proximal end portion 120 and the stem distal end portion 122 are integrally formed with each other across a continuous body shaped, for example, as a cylinder extended in the longitudinal direction of the stem 110. The stem proximal end portion 120 includes a stem proximal end 132 that is the farthest extended portion of the stem 110 backward in the longitudinal direction of the stem 110, and can have a circular profile taken from the longitudinal direction of the stem 110. The stem distal end portion 122 includes a stem distal end 134 that is the farthest extended portion of the stem 110 forward in the longitudinal direction of the stem 110 and tapers from, for example, a cylindrical profile taken from the longitudinal direction of the stem 110 into a flat brace 140 fixed to the plate 104 via, for example, fasteners 142.

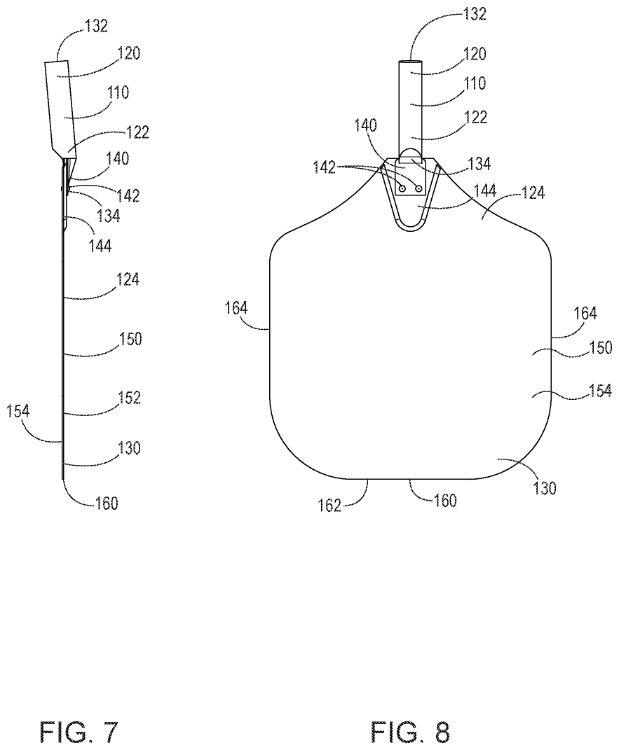

The plate proximal end portion 124 has a raised surface 144 fixed with the stem distal end portion 122 via the fasteners 142, and the plate distal end portion 130 includes a blade 150 fixed with the handle distal end portion 114 through the stem 110 and extended away from the handle proximal end portion 112, where the blade 150 forms a peel configured to separate food items (not shown) from a supporting surface (not shown). As shown in FIG. 7, the blade 150 has a bottom surface 152 configured for engaging the supporting surface, a top surface 154 for engaging food items resting on the supporting surface, and a leading edge 160 configured for separating food items from the supporting surface, where the leading edge 160 is located around the plate proximal end portion 124, and at the plate distal end portion 130, at an end of the blade 150 opposite the handle 102, at the farthest extended portion of the blade 150 from the handle 102. The leading edge 160 is interposed between and separates the bottom surface 152 and the top surface 154 of the blade 150 for separating food items from the supporting surface along the bottom surface 152 and the top surface 154. As shown in FIG. 8, the blade 150 can have a rectangular shape taken from a top view of the plate 104, the leading edge 160 is rounded at corners between a front periphery 162 and lateral side peripheries 164 of the plate 104 located with respect to the longitudinal direction of the plate 104, and the leading edge 160 is substantially straight and oriented orthogonal to the longitudinal direction of the plate 104.

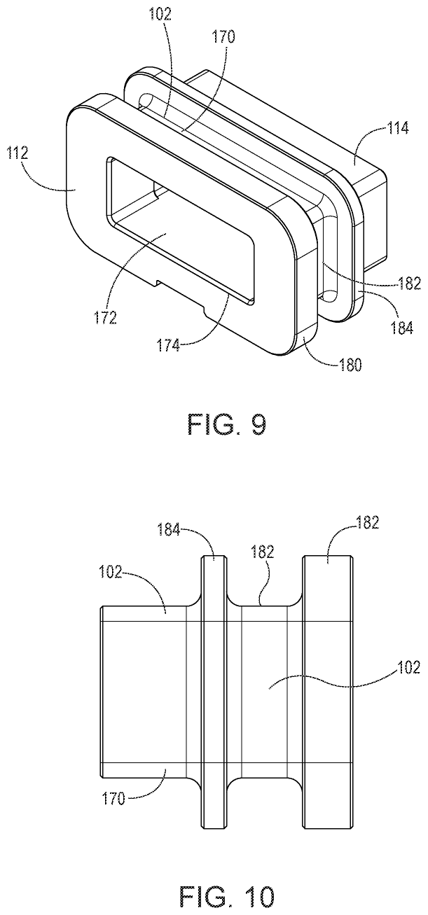

FIGS. 9-14 depict the handle 102. As shown in FIG. 9, the handle 102 is formed from a wall 170 having an interior side 172 that defines an aperture 174 configured for receiving a robot arm (not shown). The wall 170 extends from the handle proximal end portion 112 to the handle distal end portion 114, and in this manner the handle proximal end portion 112 is integrally formed with the handle distal end portion 114, such that the handle 102 defines a one-piece, unitary part.

As shown in FIG. 10, the handle 102 includes a first flange 180 extended from an exterior side 182 of the wall 170 opposite the interior side 172 of the wall 170 and defining an exterior of the handle 102, such that the first flange 180 extends in a direction away from the aperture 174 (i.e., a direction oriented orthogonal to the longitudinal direction of the handle 102). The handle 102 includes a second flange 184 extended from the exterior side 182 of the wall 170 in a direction away from the aperture 174 (i.e., a direction oriented orthogonal to the longitudinal direction of the handle 102), and located on the handle 102 offset from the first flange 180 along the longitudinal direction of the handle 102.

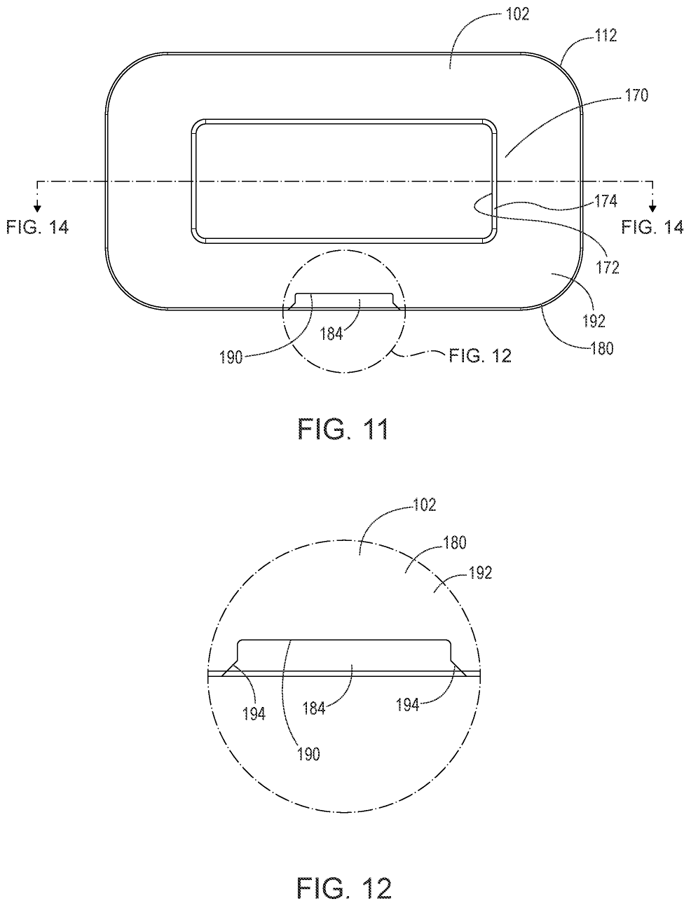

FIG. 11 depicts a front view of the handle 102. As shown in FIG. 11, the handle 102 defines a notch 190 in the first flange 180, in a handle proximal end face 192 of the handle 102 at the handle proximal end portion 112 where the second flange 184 is located behind the notch 190 in the longitudinal direction of the handle 102. The handle 102 defines the notch 190 in the handle proximal end portion 112 along the longitudinal direction of the handle 102, the notch 190 being formed in an exterior surface of the handle 102 on the exterior side 182 of the wall 170, and recessed inwardly toward the aperture 174.

The interior side 172 of the wall 170 is chamfered with the handle proximal end face 192 around a perimeter of the aperture 174. In this manner, the handle proximal end portion 112 is configured to receive a finger (not shown) of a robot arm in the aperture 174 with a reduced chance of the robot finger being caught on the proximal end face 192 at the aperture 174.

FIG. 12 depicts a partial front view of the handle 102 including the notch 190 defined in the first flange 180. As shown in FIG. 12, the notch 190 features chamfers 194 formed along the notch 190 and the first flange 180 in the longitudinal direction of the handle 102. In this manner, the notch 190 is configured for receiving a finger (not shown) of a robot arm inserted therein from a direction orthogonal to the longitudinal direction of the handle 102 with reduced chance of the robot finger being caught on the first flange 180 at the notch 190. It should be appreciated that the handle 102 is obstructed from moving in a direction orthogonal to the longitudinal direction of the handle 102 against the finger of the robot arm when the finger of the robot arm is pressed against the exterior surface of the handle 102 at the notch 190.

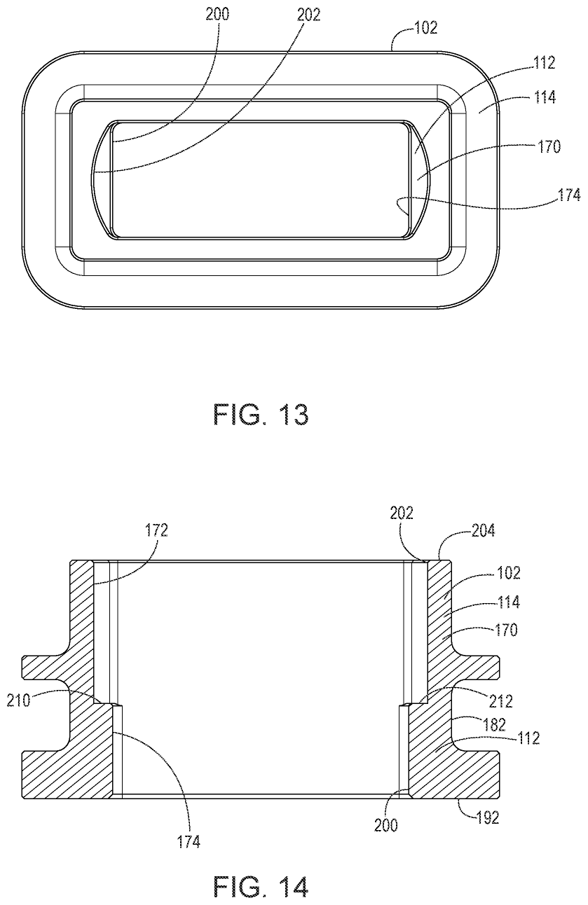

FIG. 13 depicts a back view of the handle 102. As shown in FIG. 13, the wall 170 defines the aperture 174 through the handle 102 from the handle proximal end portion 112 to the handle distal end portion 114 in the longitudinal direction of the handle 102. In this manner, the wall 170 defines a first opening 200 in the handle proximal end portion 112 and a second opening 202 in a handle distal end portion 114, where the first opening 200 and the second opening 202 each open the aperture 174 to the exterior side 182 of the wall 170. Taken from the longitudinal direction of the handle 102, the first opening 200 can be shaped as a rectangle and the second opening 202 can also be shaped as a rectangle having elongated straight sides interposed between rounded, convex sides at opposite ends. The convex sides of the second opening 202 extend further than the first opening 200 in opposite lateral directions of the handle 102 that are perpendicular to the longitudinal direction of the handle 102.

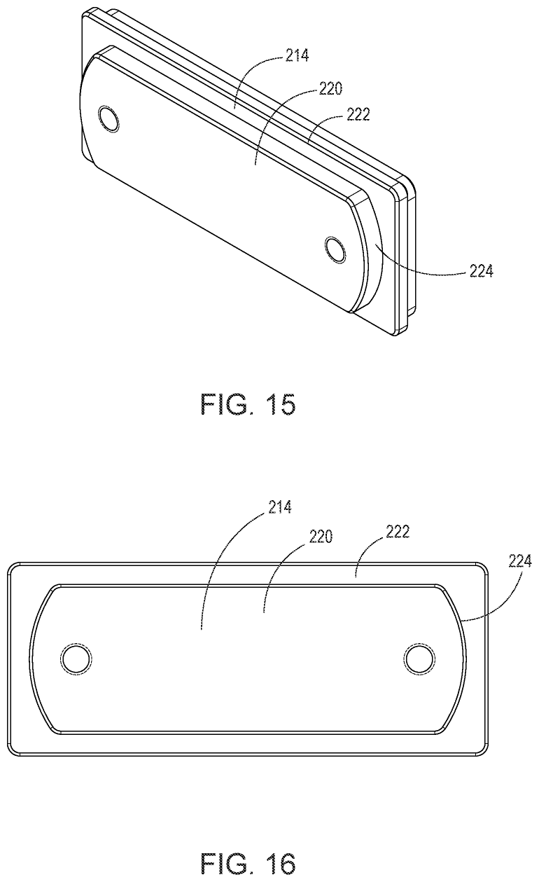

FIG. 14 depicts a cross-sectional side view of the handle 102. As shown in FIG. 14, the wall 170 defines the first opening 200 in the handle proximal end face 192 and the second opening 202 in a handle distal end face 204, where the first opening 200 and the second opening 202 each open the aperture 174 to the exterior side 182 of the wall 170. The wall 170 includes an inwardly extending ledge, such that in cross-section the ledge defines a first step 210 and a second step 212 having a same position along the longitudinal direction of the handle 102, on the interior side 172 of the wall 170, at opposite sides of the aperture 174, and extending in opposite directions orthogonal to the longitudinal direction of the handle 102. With this arrangement, a cross-sectional area of the aperture 174 taken in the longitudinal direction of the handle 102 from the handle proximal end portion 112 to the handle distal end portion 114 is larger after the first step 210 and the second step 212.

A cross-sectional area of the aperture 174 taken in the longitudinal direction of the handle 102 is longer in a first transverse direction in which the first step 210 and the second step 212 extend, the first transverse direction being orthogonal to the longitudinal direction of the handle 102, as compared to a second transverse direction orthogonal to each of the longitudinal direction of the handle 102 and the first transverse direction. In this manner, the aperture 174 is configured for receiving fingers (not shown) of a robot arm in the longitudinal direction of the handle 102, accommodating the fingers of the robot arm actuating in the opposite directions in which the first step 210 and the second step 212 extend the interior side 172 of the wall 170, and catching the fingers of the robot arm on the first step 210 and the second step 212 such that the handle 102 is obstructed from motion relative to the robot arm in the longitudinal direction of the handle 102.

FIGS. 15-18 depict a connector 214 configured to close the second opening 202 in the handle 102 and connect the handle 102 to the stem 110. As shown in FIG. 16, the connector 214 includes a plug 220 shaped for being inserted into and filling the aperture 174 at the handle distal end portion 114 to close the aperture 174 at the handle distal end portion 114. Taken from a front view, the plug 220 can be shaped as a rectangle having elongated straight sides interposed between rounded, convex sides at opposite ends, and having a size fit to the second opening 202. In this manner, the plug 220 is complementary to the second opening 202 for filling the second opening 202 when the plug 220 is inserted therein, and being fixed with the handle 102 such that the connector 214 is obstructed from rotating in any direction relative to the handle 102 or translating in any direction perpendicular to the longitudinal direction of the handle 102.

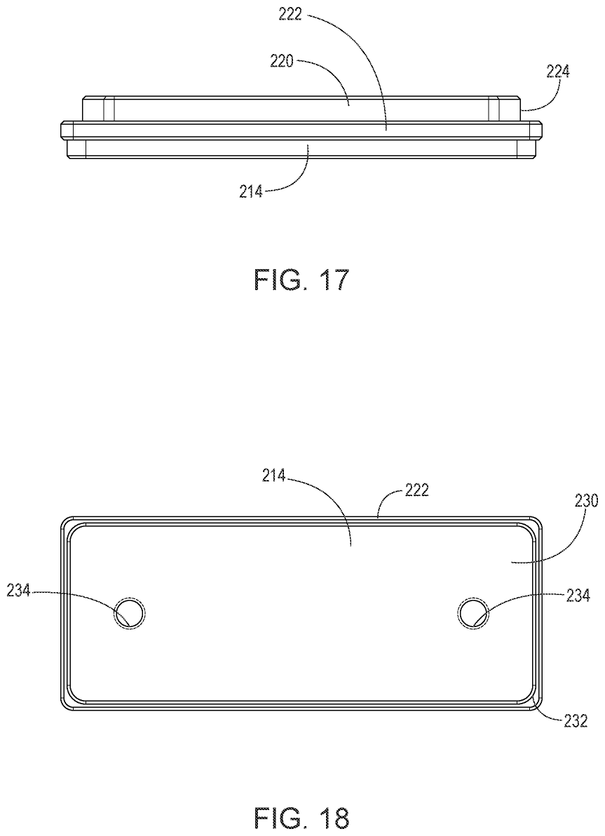

As shown in FIG. 17, the plug 220 is extended from a stop 222 in a longitudinal direction of the connector 214 that is parallel with the longitudinal direction of the handle 102 when the plug 220 is inserted in the second opening 202. The stop 222 is a plate that extends beyond an outer perimeter 224 of the plug 220 in any direction perpendicular to the longitudinal direction of the connector 214. In this manner, the stop 222 is configured to engage the wall 170 at the handle distal end face 204 and obstruct the connector 214 from passing through the aperture 174 when the plug 220 is inserted in the second opening 202. In an embodiment, the stop 222 is welded to the wall 170 once the plug 220 is inserted into the aperture 174 and the stop 222 is engaged with the handle distal end face 204.

As shown in FIG. 18, the stop 222 includes a protrusion 230 extended from a side of the stop 222 opposite the plug 220 in the longitudinal direction of the connector 214. The protrusion 230 has an outer perimeter 232 located inward of the stop 222 in a lateral direction of the connector 214 orthogonal to the longitudinal direction of the connector 214. The protrusion 230 defines holes 234 extended into the stop 222 and configured for receiving fasteners. In an embodiment, the holes 234 are through holes extended through the stop 222 and the plug 220 for receiving fasteners and fixing the connector 214 to the handle 102. While the depicted protrusion 230 defines two holes 234 therein, the protrusion 230 may define more or fewer holes having similar features and functioning in a similar manner as the holes 234 without departing from the scope of the present disclosure.

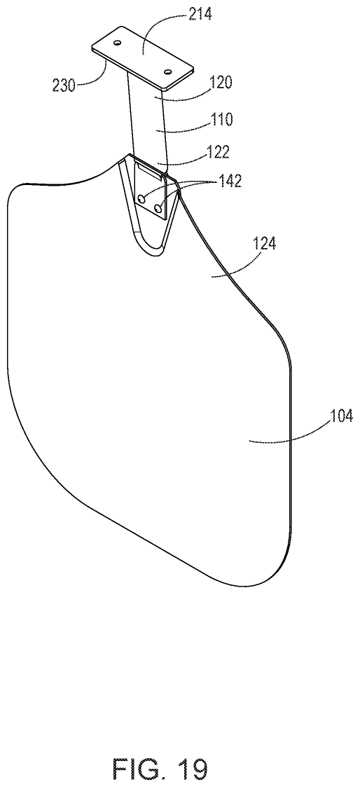

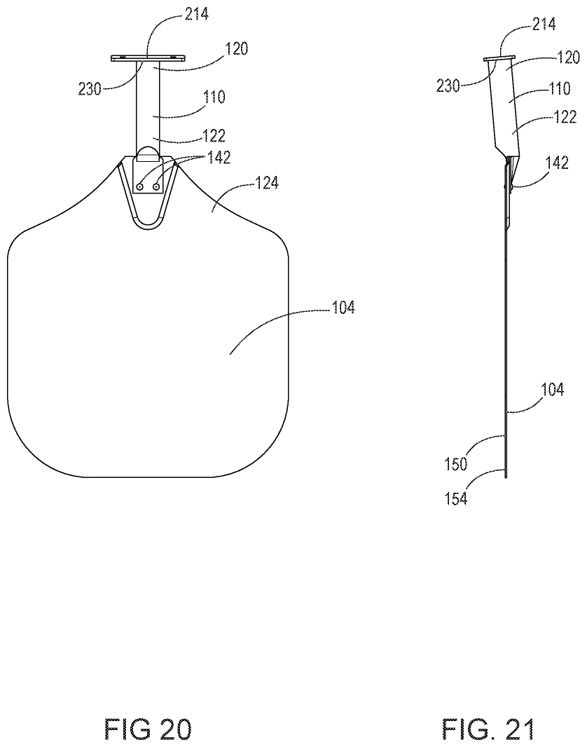

FIGS. 19-22 depict the plate 104, the stem 110, and the connector 214 assembled together, with the stem proximal end portion 120 fixed to the connector 214 at the protrusion 230, and the stem distal end portion 122 fixed to the plate 104 at the plate proximal end portion 124. As shown in FIG. 19, the connector 214 is fixedly attached (i.e., welded) with the stem 110 between the stem proximal end portion 120 and the protrusion 230, and the plate 104 is fixed with the stem distal end portion 122 via the fasteners 142. While the depicted fasteners 142 are rivets, the fasteners may additionally or alternatively include screws, bolts, nails, or other types of fasteners without departing from the scope of the present disclosure. While the depicted connector 214 is welded to the stem 110 and the depicted plate 104 is fixed to the stem 110 via the fasteners 142, the connector 214 may additionally or alternatively be fixed to the stem 110 via fasteners that have similar features and function in a similar manner as the fasteners, and the plate 104 may additionally or alternatively be welded to the stem 110.

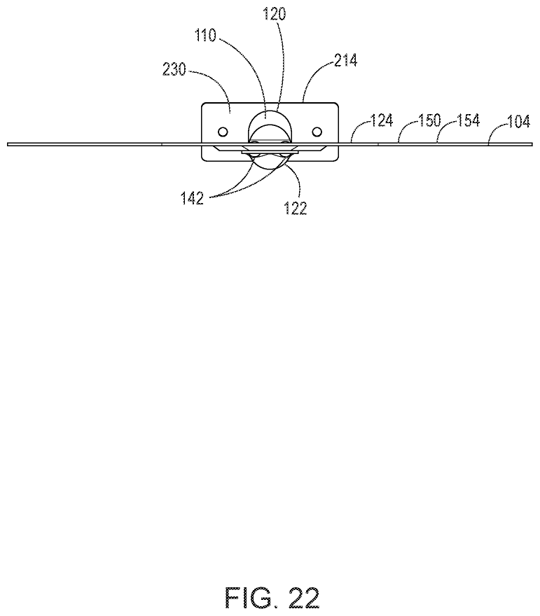

As shown in FIGS. 21 and 22, the stem 110 and the connector 214 are angled toward the top surface 154 of the blade 150, forming an angular offset between the longitudinal direction of the plate 104 and each of the longitudinal direction of the stem 110 and the longitudinal direction of the connector 214.

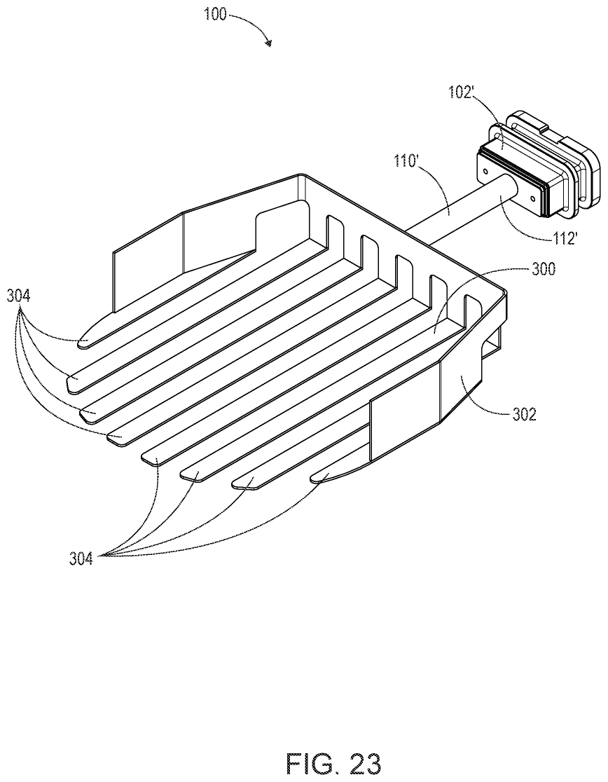

FIGS. 23-27 depict an alternate embodiment of the end effector 100 of FIGS. 1-22. In the embodiment of FIGS. 23-27, like elements with the end effector 100 of FIGS. 1-22 are denoted with the same reference numerals but followed by a primed suffix (′).

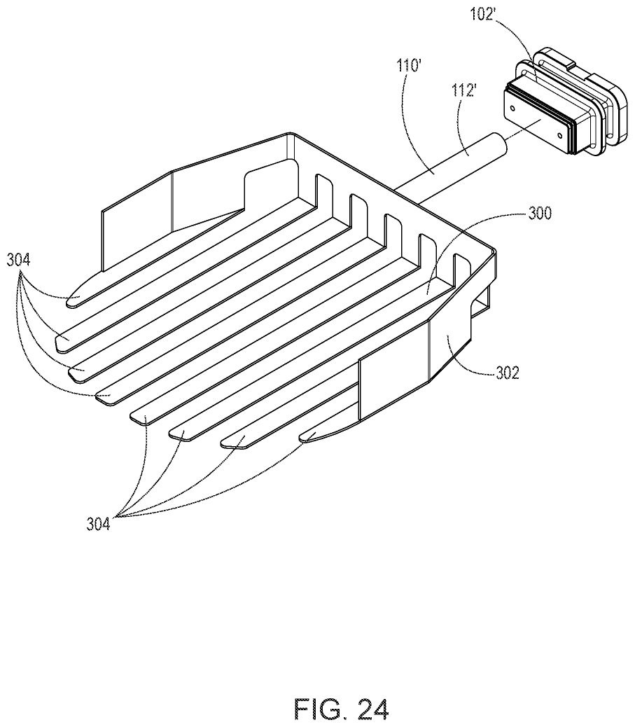

FIGS. 23-27 depict an embodiment of the end effector 100 including a plate 300 fixed with the stem distal end portion 122′ through the stem 110′. As shown in FIGS. 23 and 24, the plate 300 includes a backing 302 fixed with the stem 110′ and a plurality of blades 304 integrally formed with the backing 302 and extended away from the stem 110′ and the handle 102′, including the handle proximal end portion 112′ configured for receiving a robot arm (not shown). The plurality of blades 304 extend from the backing 302 in a longitudinal direction of the plate 300 that is parallel with the longitudinal direction of the handle 102′ and the longitudinal direction of the stem 110′, such that the plurality of blades 304 extend in parallel with each other and are offset from each other in a lateral direction of the plate 300 perpendicular to the longitudinal direction of the plate 300.

In an embodiment, the backing 302 and the plurality of blades 304 are formed together from a single piece of pressed sheet metal. In an alternative embodiment, the plate 300 includes the backing 302 and the plurality of blades 304 welded together. While, as depicted, the backing 302 and the plurality of blades 304 are integrally formed with each other in the plate 300, the backing 302 and the plurality of blades 304 may be alternatively fastened together from distinct elements without departing from the scope of the present disclosure.

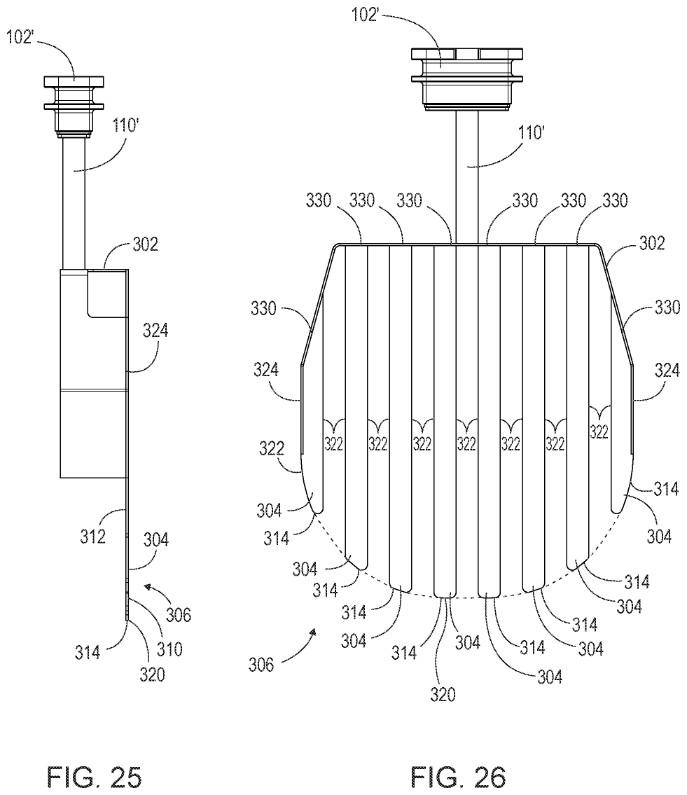

As shown in FIG. 25, the plurality of blades 304 forms a peel 306 configured to separate food items from a supporting surface, where each blade 304 in the plurality of blades 304 respectively includes a bottom surface 310 configured for engaging the supporting surface, a top surface 312 for engaging food items resting on the supporting surface, and a leading edge 314 configured for separating food items from the supporting surface at a front periphery 320 of the peel 306. The plurality of blades 304 extend parallel to each other, approximately straight from the backing 302 in the longitudinal direction of the handle 102′ such that the bottom surface 310 and the top surface 312 of each blade 314 are flat and arranged in parallel with each other.

The top surfaces 312 of the plurality of blades 304 are located below the stem 110′ when the end effector 100 is oriented in an upright position where the top surfaces 314 have a horizontal orientation and face vertically upward. In this manner, the plate 300 is configured to retain food items with a center of mass located below the stem 110, stabilizing the handle 102, the stem 110, and the plate 300 from rotating around the stem 110 in a circumferential direction of the stem due to weight of the food items, and the plate 300 is configured to support the peel 306 with the backing 302 in suspension between the stem 110 and the peel 306 when the end effector 100 is oriented in the upright position.

Each leading edge 314 in the plurality of blades 304 is respectively located at an end of a corresponding blade 304 opposite the handle 102′, and is the farthest extended portion of the blade 304 from the handle 102′. Taken from a top view depicted in FIG. 26, blades 304 in the plurality of blades 304 which are arranged closer to the handle 102′ in the lateral direction of the handle 102′ extend farther in the longitudinal direction of the handle 102′ as compared to blades arranged farther from the handle 102′ in the lateral direction of the handle 102′. Each blade 304 in the plurality of blades 304 extends in the longitudinal direction of the handle 102′ and is rounded at corners formed between the leading edge 314 and lateral side peripheries 322 of the blade 304 extended from the back periphery 330 to the front periphery 320 in the longitudinal direction of the plate 300. As shown in FIG. 26, each leading edge 314 in the plurality of blades 304 is substantially straight and angled such that the front periphery 320 of the peel 306 follows a curve in the longitudinal direction of the handle 102′ that has a semicircular shape.

As shown in FIGS. 25-27, the backing 302 is arranged perpendicular to the longitudinal direction of the plate 300 and the lateral direction of the plate 300 in which the plurality of blades 304 are offset from each other, and arranged along outermost lateral side peripheries 324 of the peel 306 in the lateral direction of the plate 300. With reference to FIG. 26, the backing 302 is arranged along back peripheries 330 of the plurality of blades 304, connecting the plurality of blades 304 to each other, the back peripheries 330 being located closer to the handle 102′ as compared to the front periphery 320, at a side of the plurality of blades 304 opposite the front periphery 320 in the longitudinal direction of the plate 300. In this manner, the backing 302 is configured to support the plurality of blades 304 in the peel 306 and retain food items on the peel 306 by catching the food items on the top surfaces 312 of the plurality of blades 304 and obstructing the food items from sliding off the top surfaces 312 from the back peripheries 330 in the longitudinal direction of the plate 300, and from sliding off the top surfaces 312 from the outermost lateral side peripheries 324 in the lateral direction of the plate 300.

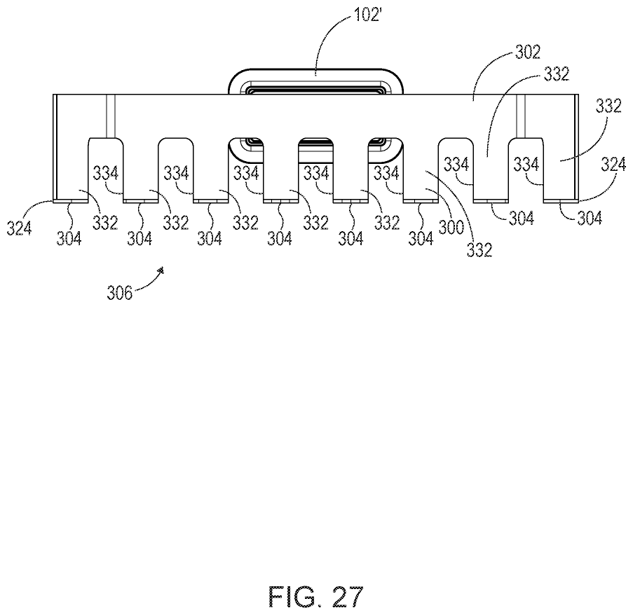

As shown in FIG. 27, the backing 302 includes a plurality of projections 332 extended in a direction perpendicular to the longitudinal direction of the plate 300 and the lateral direction of the plate 300, the plurality of projections 332 being sized and arranged to extend gaps 334 defined between the plurality of blades 304 in the lateral direction of the plate 300 into the backing 302, around a corner formed between the backing 302 and the plurality of blades 304. To this end, the plurality of projections 332 each have widths in the lateral direction of the plate 300 equal to corresponding blades 304 in the plurality of blades 304 and are offset from each other in the lateral direction of the plate 300 to match lateral positions of blades 304 in the plurality of blades 304. With the plurality of blades 304 fixed to the plurality of projections 332 and offset from each other in the lateral direction of the plate 300, the plurality of blades 304 and the plurality of projections 332 define the gaps 334 therebetween in the lateral direction of the plate 300. In this manner, the plate 300 is configured for separating food items from a support surface, and retaining food items in the plate 300 against the backing 302 while dropping crumbs or other relatively small portions of the food items in the plate 300 between the gaps 334, preventing the crumbs or other portions of the food items from collecting in the plate 300.

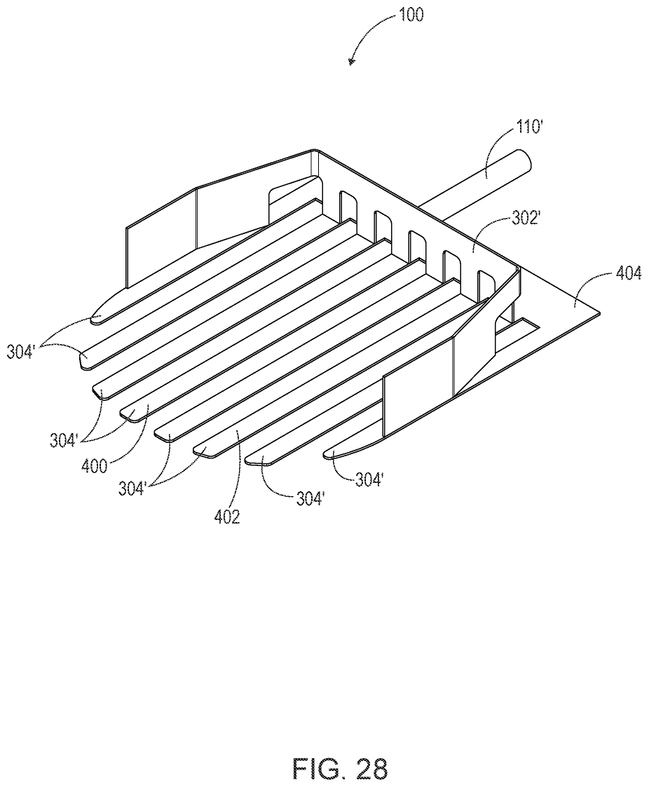

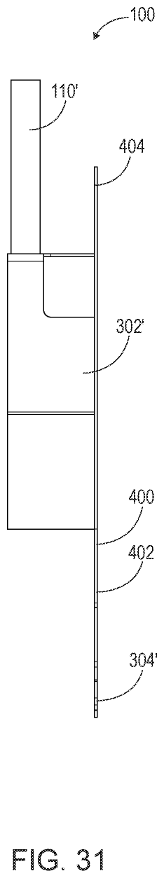

FIGS. 28-31 depict an alternate embodiment of the end effector 100 of FIGS. 23-27. In the embodiment of FIGS. 28-31, like elements with the end effector 100 of FIGS. 23-27 are denoted with the same reference numerals but followed by a primed suffix (′).

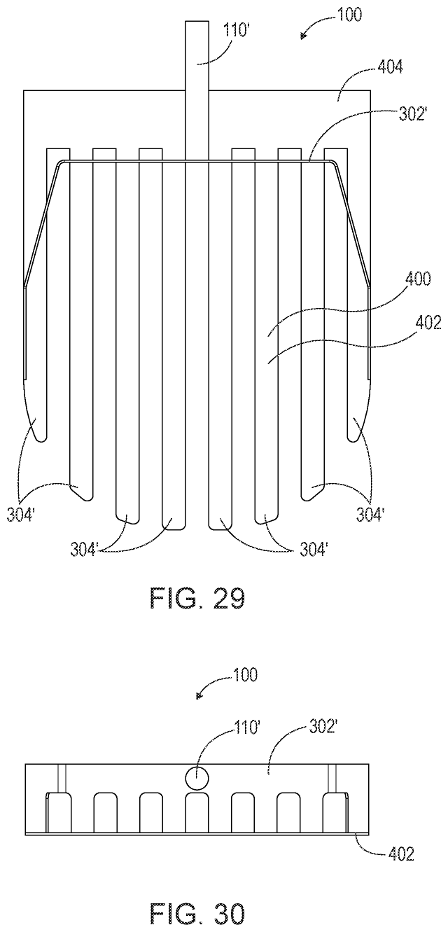

FIGS. 28-31 depict an embodiment of the end effector 100 including a plate 400 with the backing 302′ fixed to the stem distal end portion 122′ through the stem 110′. The plate 400 includes a panel 402 forming the plurality of teeth 304′ fixed to the backing 302′. As depicted in FIGS. 28 and 29, the panel 402 extends the plurality of teeth 304′ beyond the backing 302′, backward in a longitudinal direction of the plate 400, in parallel with the longitudinal direction of the stem 110′. The plurality of blades 304′ are connected to each other in a lateral direction of the plate 400 across the backing 302′ and a flange 404 integrally formed with the plurality of blades 304′. While the depicted backing 302′ is welded to the plurality of blades 304′, the backing 302′ may additionally or alternatively be fixed to the plurality of blades 304′ by brazing, soldering, or fasteners such as screws, bolts, or rivets without departing from the scope of the present disclosure.

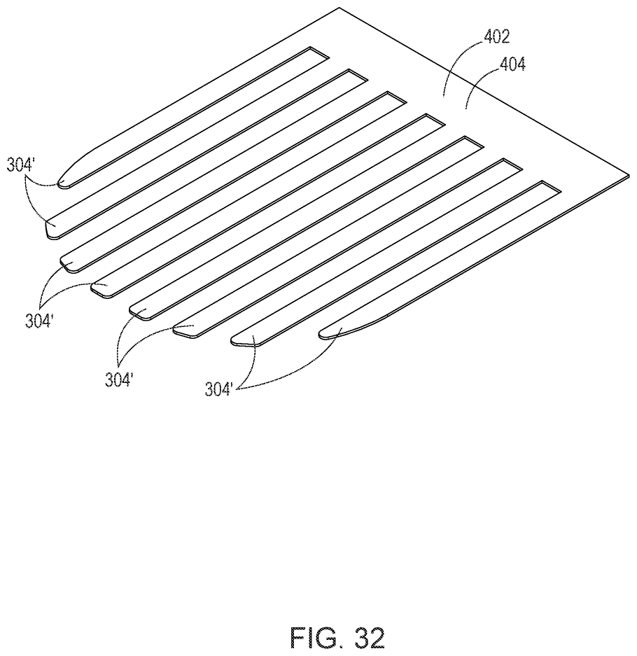

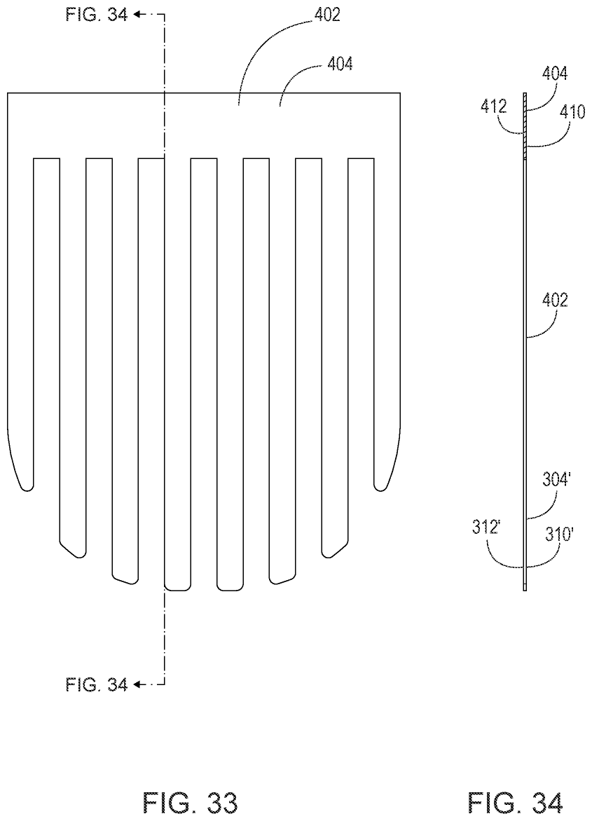

FIGS. 32-34 depict the panel 402. As depicted between FIGS. 33 and 34, the flange 404 is a pane extended in the longitudinal direction of the plate 400 along the stem 110′ and the lateral direction of the plate 400. Taken from a top view shown in FIG. 33, the flange 404 can be shaped as a rectangle elongated in the lateral direction of the plate 400. Taken from a side view shown in FIG. 34, the flange 404 extends straight in the longitudinal direction of the plate 400 to form the bottom surface 310′ of the plurality of blades 304′, a bottom surface 410 of the flange 404 continuous with the bottom surface 310′ of the plurality of blades 304′, the top surface 312′ of the plurality of blades 304′, and a top surface 412 of the flange 404 continuous with the top surface 312′ of the plurality of blades 304′ flat and parallel with each other in the longitudinal direction of the plate 400.

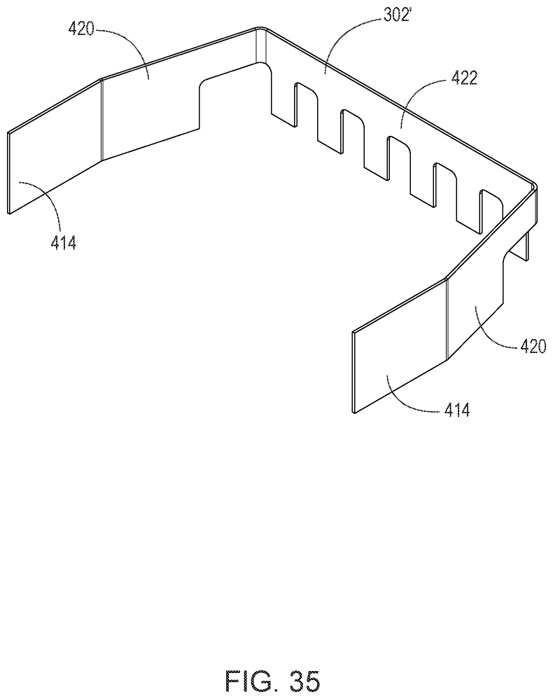

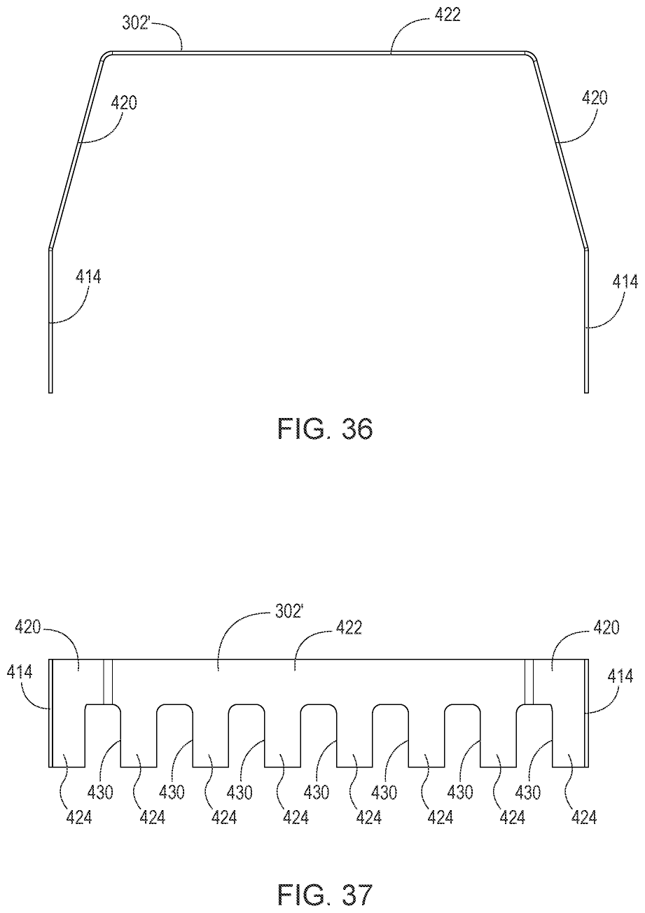

FIGS. 35-37 depict the backing 302′. As depicted between FIGS. 35 and 36, the backing 302′ includes lateral side portions 414 extended in parallel with each other in the longitudinal direction of the plate 400, offset from each other in the lateral direction of the plate 400 a distance equal to a distance between the outermost lateral side peripheries 324′ of the plurality of blades 304′ in the lateral direction of the plate 400. The lateral side portions 414 are each integrally formed with an intermediate portion 420 extended backward in the longitudinal direction of the plate 400, toward a center of the plate 400 in the lateral direction of the plate 400. The intermediate portions 420 are integrally formed with and connected to each other by a back portion 422 extended in the lateral direction of the plate 400.

FIG. 37 depicts a front view of the backing 302′. As shown in FIG. 37, the back portion 422 includes a plurality of projections 424 extended in a direction perpendicular to the longitudinal direction of the plate 400 and the lateral direction of the plate 400, and configured for being attached to the plurality of blades 304′. The plurality of projections 424 each have widths in the lateral direction of the plate 400 equal to corresponding blades 304′ and are offset from each other in the lateral direction of the plate 400 to match lateral positions of the plurality of blades 304′. As shown in FIG. 28, with the plurality of blades 304′ fixed to the plurality of projections 424 and offset from each other in the lateral direction of the plate 400, the plurality of blades 304′ and the plurality of projections 424 define gaps 430 therebetween in the lateral direction of the plate 400. In this manner, the plate 400 is configured for separating food items from a support surface, and retaining food items in the plate 400 against the backing 302′ while dropping crumbs or other portions of the food items in the plate 400 between the gaps 430, preventing the crumbs or other portions of the food items from collecting in the plate 400.

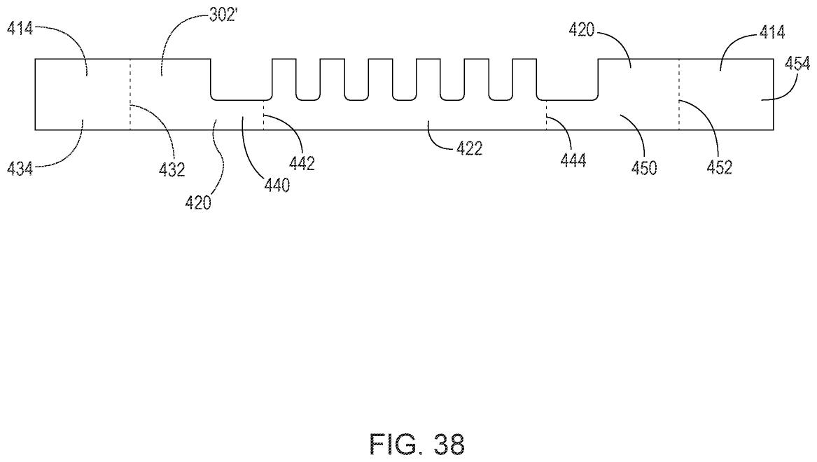

FIG. 38 depicts the backing 302′ in an intermediate stage of manufacture, as a flat plate formed from a single band of material where the lateral side portions 414, the intermediate portions 420, and the back portion 422 extend in a same direction. In a method of forming the backing 302′ from the flat plate shown in FIG. 38, the backing 302′ is bent along a first fold line 432 to form a corner interposed between a first lateral side portion 434 of the lateral side portions 414 and a first intermediate portion 440 of the intermediate portions 420, the backing 302′ is bent along a second fold line 442 to form a corner interposed between the first intermediate portion 440 and the back portion 422, the backing 302′ is bent along a third fold line 444 to form a corner interposed between the back portion 422 and a second intermediate portion 450 of the intermediate portions 420, and the backing 302′ is bent along a fourth fold line 452 to form a corner interposed between the second intermediate portion 450 and a second lateral side portion 454. In this manner, as shown in FIG. 23, the backing 302′ is formed with a bent U shape matching an arrangement of the outermost lateral side peripheries 324′ and back peripheries 330′ of the plurality of blades 304′.

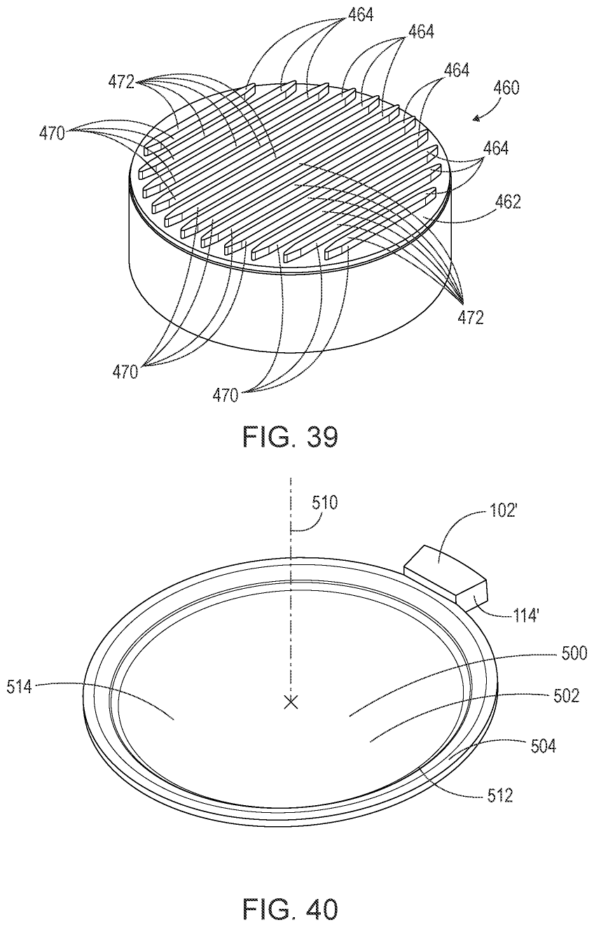

FIG. 39 depicts a perspective view of a base 460 for an automated food preparation system configured for supporting food items thereon, the base 460 including a supporting surface 462 and ejector pins 464, where the plurality of blades 304′ are configured to separate food items from the supporting surface 462. The ejector pins 464 are configured for being actuated to a retracted position (not shown) where the ejector pins 464 are flush with the supporting surface 462, and configured for being actuated to an extended position where, as shown in FIG. 39, where the ejector pins 464 are projected beyond the supporting surface 462 in a direction orthogonal to a direction along the supporting surface 462, and offset from each other in a lateral direction of the base 460 along the supporting surface 462 to define at least one gap 470 configured for receiving a corresponding blade 304 in the plurality of blades 304 therebetween when the ejector pins 464 are actuated to the extended position.

The at least one gap 470 is wider than the corresponding blade 304 in the lateral direction of the base 460 such that the corresponding blade 304 is configured for being inserted in the at least one gap 470, where the bottom surface 310 is configured for engaging the supporting surface 462 or extending along and spaced from the supporting surface 462 interposed between and separating the ejector pins 464 across the at least one gap 470 in a direction parallel to the supporting surface 462, and the top surface 312 is configured for engaging food items from a position between protruding ends 472 of the ejector pins 464 and the supporting surface 462 in a direction in which the ejector pins 464 are actuated. According to one aspect, the depicted base 460 is a pressing machine base configured to shape dough into a pizza crust, and the supporting surface 462 has a circular shape complementary with the semicircular shape of the peel 306 along the front periphery 320 of the plate 300.

FIG. 40 depicts an embodiment of the end effector 100 of FIGS. 1-22. In the embodiment of FIG. 40, like elements of the end effector 100 of FIGS. 1-22 are denoted with the same reference numerals but followed by a primed suffix (′). FIG. 40 depicts a plate 500 fixed directly with the handle 102′, without a stem connecting the plate 500 and the handle 102′. The plate 500 includes a plate main body 502 and a rim 504 integrally formed with the plate main body 502 and fixed with the handle distal end portion 114′, extended in the longitudinal direction of the handle 102′, and extended in a direction orthogonal to the longitudinal direction of the handle 102′. The plate 500, including each of the plate main body 502 and the rim 504, is circular with respect to a central axis 510 oriented orthogonal to the longitudinal direction of the handle 102′ and the lateral direction of the handle 102′.

The rim 504 extends from an outer periphery 512 of the plate main body 502 in a direction orthogonal to the plate main body 502, along the central axis 510 of the plate 500. In this manner, the rim 504 is configured to retain food items on a top surface 514 of the plate main body 502 by obstructing the food items from traveling off the plate 500 in the radial direction of the plate 500. The plate 500 is fixed to the handle distal end portion 114′ at an outer periphery 514 of the rim 504 with respect to a radial direction of the plate 500 orthogonal to the central axis 510 of the plate 500.

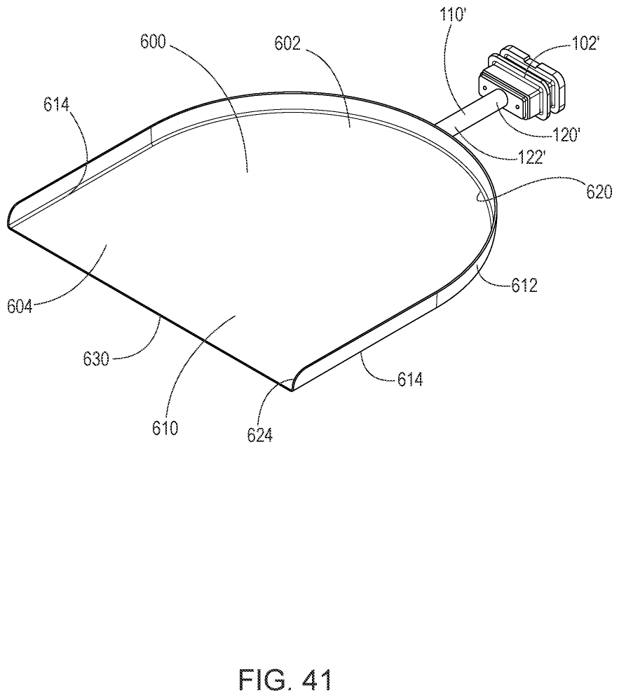

FIG. 41 depicts an embodiment of the end effector 100 of FIGS. 1-22. In the embodiment of FIG. 41, like elements of the end effector 100 of FIGS. 1-22 are denoted with the same reference numerals but followed by a primed suffix (′). FIG. 41 depicts a plate 600 connected to the handle 102′ through the stem 110′, the stem distal end portion 122′ being fixed directly with a plate proximal end portion 602. A plate distal end portion 604 extends from the plate proximal end portion 602 in a longitudinal direction of the plate 600 parallel with the longitudinal direction of the handle 102′.

The plate includes a blade 610 that is a flat pane extended from the plate proximal end portion 602 to the plate distal end portion 604, and a side wall 612 located along lateral side peripheries 614 and a back periphery 620 of the blade 610, and extended from the blade 610 in a direction perpendicular to the longitudinal direction of the plate 600 and a lateral direction of the plate 600.

In this manner, the side wall 612 is configured to retain food items on a top surface 622 of the blade 610 by obstructing the food items from traveling off the plate 600 in the radial direction of the plate 600, over either of the lateral side peripheries 614 or the back periphery 620. The side wall 612 defines a plate opening 624 across a front periphery 630 in the lateral direction of the plate 600 between portions of the side wall 612 at the lateral side peripheries 614, where the front periphery 630 of the blade 610 forms a leading edge of the blade 610 configured to separate food items from a supporting surface such that the food items are retained on the top surface 622 by the side wall 612.

It will be appreciated that various embodiments of the above-disclosed and other features and functions, or alternatives or varieties thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

1. An end effector comprising:
a handle having a handle proximal end portion and a handle distal end portion extended from the handle proximal end portion in a longitudinal direction of the handle, the handle being formed from a wall closed around the longitudinal direction of the handle with an interior side of the wall that defines an aperture configured for receiving an associated robot arm and extended from the handle proximal end portion to the handle distal end portion; and
a plate fixed with the handle distal end portion, and extended away from the handle proximal end portion.

2. The end effector of claim 1, wherein the handle defines a notch in the handle proximal end portion along the longitudinal direction of the handle, the notch being formed in an exterior surface of the handle recessed toward the aperture.

3. The end effector of claim 2, wherein the handle includes a first flange extended from an exterior side of the wall opposite the interior side of the wall, in a direction away from the aperture, and
wherein the notch is defined in the first flange.

4. The end effector of claim 3, wherein the handle includes a second flange extended from the exterior side of the wall in a direction away from the aperture, offset from the first flange along the longitudinal direction of the handle, and located behind the notch in the longitudinal direction of the handle.

5. The end effector of claim 2, wherein the notch is defined in a proximal end face of the handle.

6. The end effector of claim 1, wherein the wall includes a step along the longitudinal direction of the handle on the interior side of the wall such that a cross-sectional area of the aperture taken in the longitudinal direction of the handle from the handle proximal end portion to the handle distal end portion is larger after the step.

7. The end effector of claim 1, wherein the wall includes a step on the interior side of the wall and the aperture is wider in a direction of the step as compared to a direction perpendicular to the direction of the step.

8. The end effector of claim 1, wherein the plate includes a plate main body fixed with the handle distal end portion, extended in the longitudinal direction of the handle, and extended in a direction orthogonal to the longitudinal direction of the handle, and includes a rim extended from an outer periphery of the plate main body, in a direction orthogonal to the plate main body.

9. The end effector of claim 1, wherein the plate includes at least one blade that forms a peel configured to separate associated food items from an associated supporting surface.

10. The end effector of claim 1, wherein the plate includes a plurality of blades that forms a peel configured to separate associated food items from an associated supporting surface, the plurality of blades extending in the longitudinal direction of the handle and offset from each other in a direction orthogonal to the longitudinal direction of the handle such that each blade has a bottom surface configured for engaging the associated supporting surface, a top surface for engaging the associated food items on the associated supporting surface, and a leading edge configured for separating the associated food items from the associated supporting surface, wherein the leading edge is located at an end of the blade opposite the handle and is the furthest portion of the blade from the handle.

11. The end effector of claim 10, wherein blades in the plurality of blades which are arranged closer to the handle extend further in the longitudinal direction of the handle as compared to blades arranged farther from the handle.

12. The end effector of claim 1, wherein the plate includes a front periphery, a back periphery located closer to the handle as compared to the front periphery, and side peripheries extending from the back periphery to the front periphery in the longitudinal direction of the handle,
wherein the plate has a backing that extends along the back and side peripheries of the plate, and is formed from a single band of material.

13. The end effector of claim 12, further comprising a stem connecting the handle to the plate, the stem having a stem proximal end portion fixed to the handle and a stem distal end portion extended from the stem proximal end portion in the longitudinal direction of the handle and fixed to the backing at the back periphery of the plate.

14. The end effector of claim 12, wherein the backing is integral with the plate to define a one-piece, unitary part.

15. The end effector of claim 1, wherein the wall defines the aperture from the handle proximal end portion to the handle distal end portion in the longitudinal direction of the handle, the handle includes a weld connector inserted in the aperture at the handle distal end portion, and includes a stem connecting the handle to the plate, the stem having a stem proximal end portion fixed to the weld connector and a stem distal end portion fixed to the plate.

16. The end effector of claim 1, wherein the aperture has a cross-sectional area taken in the longitudinal direction of the handle, the cross-sectional area being longer in a first transverse direction orthogonal to the longitudinal direction of the handle as compared to a second transverse direction orthogonal to each of the longitudinal direction of the handle and the first transverse direction.

17. An automated food preparation system comprising:
an end effector including:
a handle having a handle proximal end portion and a handle distal end portion extended from the handle proximal end portion in a longitudinal direction of the handle; and
a plate fixed with the handle distal end portion, and including at least one blade extended away from the handle proximal end portion in the longitudinal direction of the handle; and
a base including:
a supporting surface; and
ejector pins arranged in the supporting surface, configured for being actuated to a retracted position where the ejector pins are flush with the supporting surface, and configured for being actuated to an extended position where the ejector pins are projected from the supporting surface, the ejector pins being offset from each other to define at least one gap therebetween along the supporting surface when actuated to the extended position,
wherein the at least one gap is wider than the at least one blade such that the at least one blade is configured for being inserted in the at least one gap, the blade having a bottom surface configured for engaging or facing the supporting surface from a position interposed between and separating the ejector pins across the at least one gap along the supporting surface, and a top surface configured for engaging associated food items from a position between protruding ends of the ejector pins and the supporting surface in a direction in which the ejector pins are actuated.

18. The automated food preparation system of claim 17, wherein the base is a pressing machine base configured to shape dough.

19. The automated food preparation system of claim 17, wherein a front periphery of the plate defined by the at least one blade is curved in the longitudinal direction of the handle.

20. The automated food preparation system of claim 17, wherein the at least one blade is a plurality of blades extended in the longitudinal direction of the handle and in parallel with each other, the at least one gap is a plurality of gaps corresponding to the plurality of blades, the plurality of blades being positioned offset from each other in a direction orthogonal to the longitudinal direction of the handle, and respectively configured for being inserted in the plurality of gaps along the supporting surface.
